(19) United States
(12) Patent Application Publication
(10) Pub. No.: US 2012/0015253 A1
(43) Pub. Date: Jan. 19, 2012

(54) BATTERY MANUFACTURING METHOD, BATTERY, VEHICLE AND ELECTRONIC DEVICE

(76) Inventors: Takeshi Matsuda, Kyoto (JP); Masakazu SANADA, Kyoto (JP); Kenta HIRAMATSU, Kyoto (JP)

(21) Appl. No.: 13/181,928

(22) Filed: Jul. 13, 2011

(30) Foreign Application Priority Data
Jul. 13, 2010 (JP) 2010-158454

(51) Int. Cl. H01M 4/64; H01M 10/04

(52) U.S. Cl. 429/233; 29/623.5

(57) ABSTRACT

Stripe-shaped pattern elements 121 projecting from a surface of a substantially flat negative-electrode current collector 11 are formed by applying an application liquid containing a negative-electrode active material by a nozzle-scan coating method. Subsequently, an application liquid containing a solid electrolyte material is applied, for example, by a spin coating method to form a solid electrolyte layer 13. A thickness Te of the solid electrolyte layer 13 covering exposed surfaces 11a of the negative-electrode current collector exposed between the stripe-shaped pattern elements 121 is set to be smaller than a height Ha of the stripe-shaped pattern elements 121, taking into account that part of the application liquid applied on the stripe-shaped pattern elements 121 flows down toward the exposed surfaces 11a.

### CROSS REFERENCE TO RELATED APPLICATION

The disclosure of Japanese Patent Application No. 2010-158454 filed on Jul. 13, 2010 including specification, drawings and claims is incorporated herein by reference in its entirety.

### BACKGROUND OF THE INVENTION

1. Field of the Invention

This invention relates to a method for manufacturing a battery in which a solid electrolyte layer is interposed between active material layers, a battery having such structure, and a vehicle and an electronic device including this battery.

2. Description of the Related Art

Conventionally, as a method for producing a chemical battery such as a lithium-ion secondary battery, a technology for laminating metal foils as current collectors having respectively positive-electrode or negative-electrode active materials attached thereto with a separator disposed therebetween and impregnating the separator with an electrolytic solution has been known. However, a battery including a highly volatile organic solvent as an electrolytic solution needs to be carefully handled. Further, for required further miniaturization and higher output, a technology for producing an all-solid-state battery by microfabrication using a solid electrolyte in place of an electrolytic solution has been and is being proposed in recent years.

For example, JP 2005-116248A (hereinafter, referred to as “patent literature 1”) discloses a technology for forming an active material layer having an uneven surface on a metal foil, which will become a current collector, by an ink-jet method and successively three-dimensionally laminating a solid electrolyte layer and another active material layer by the ink-jet method so as to flatten the unevenness. In this technology, the above space structure is obtained by laminating a multitude of layers mixedly including different functional layers such as the positive and negative active material layers and the solid electrolyte layer formed by one printing process by recoating. At this time, every time one layer is applied, a drying treatment is performed to volatilize a solvent contained in ink.

Since used amounts and dimensions of materials such as active materials and electrolyte largely influence battery capacity and charge and discharge characteristics, a battery needs to be manufactured with these set in a suitably balanced manner to have a thin size and excellent characteristics. However, sufficient studies have not been made on this point thus far in conventional technologies. In the conventional technology disclosed in the above patent literature, many processes are necessary to obtain a desired space structure. Thus, there is room for further improvement to manufacture a battery having such a space structure at a practical level.

In view of the above problems, an object of this invention is to provide a battery which uses a solid electrolyte and has a thin size and excellent electrochemical properties and a device including this battery.

To achieve above object, a battery manufacturing method of the present invention comprises: an active material applying step of applying a first application liquid containing a first active material on a surface of a base material to form a projection of the first active material projecting from the surface of the base material; and an electrolyte layer forming step of applying a second application liquid containing a solid electrolyte material on the surface of the base material formed with the projection to form an electrolyte layer, which covers a surface of the projection and an exposed surface of the base material where the projection is not formed, of the solid electrolyte material, wherein a thickness of the electrolyte layer covering the exposed surface of the base material is set to be smaller than a height of the projection from the base material surface.

Since the surface area of the first active material can be increased with respect to the used amount (volume) thereof by forming the projection of the first active material on the base material surface, charge and discharge characteristics of the battery can be improved. On the other hand, in the case of using a solid electrolyte material having lower ionic conductivity than an electrolytic solution, an electrolyte layer interposed between both positive and negative-electrode active materials needs to be thin. However, if a thickness of the electrolyte layer around the projection is larger than a height of the projection formed of the first active material, the significance of providing the active material with unevenness is lost and the both positive and negative-electrode active materials face each other via the thick electrolyte layer. This problem is particularly notable when an electrolyte layer is formed by applying an application liquid containing the electrolyte to the structure in which the projection made of the first active material is provided on the base material surface. This is because the application liquid applied on the projection flows down to the exposed surface of the base material located at a lower position and the thickness of the electrolyte layer increases in this part. Thus, to obtain a battery with good characteristics, it is important to appropriately manage the thickness of the electrolyte layer covering the exposed surface of the base material.

Accordingly, in the battery manufacturing method according to this invention, focusing on a part of the electrolyte layer covering the exposed surface of the base material, the thickness of the electrolyte layer in this part is managed to be smaller than the height of the projection. Hence, a thin electrolyte layer which enables active materials to face each other in a wide area can be reliably obtained. Thus, according to this invention, a battery with a thin size and excellent electrochemical properties can be manufactured. Further, since the entire solid electrolyte layer needs not necessarily have a uniform thickness, an application method is not limited to a special one and various application methods can be employed provided that they can control a film thickness on the exposed surface of the base material.

Further, a battery of the present invention comprises: a first current collector layer; a first active material layer; a solid electrolyte layer; a second active material layer; and a second current collector layer, wherein at least the first active material layer and the solid electrolyte layer are formed by the manufacturing method according to claim 1 using the first current collector layer as the base material. In the invention thus constructed, the first and second active material layers face each other via the thin solid electrolyte. Therefore, the battery according to the invention is a battery using a solid electrolyte and having a thin size and excellent electrochemical properties.

There are various fields of application for the battery having the above structure. For example, the battery can be applied as a power supply for various vehicles such as electric vehicles and can be applied to various electronic devices including a circuit unit which operates using this battery as a power supply.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1A is a perspective view of a lithium-ion secondary battery as one embodiment of a battery according to the invention;

FIG. 1B is a drawing which shows a cross-sectional structure of this battery;

FIG. 2 is a flow chart which shows an example of a method for manufacturing the battery of FIG. 1A;

FIG. 3A is a drawing which shows a state of application by the nozzle-scan coating method when viewed in the X-direction;

FIGS. 3B and 3C are drawings showing the same state when viewed in the Y-direction and from a diagonal upper side;

FIG. 4 is a drawing which diagrammatically shows a state of material application by the spin coating method;

FIGS. 5A, 5B and 5C are views which diagrammatically show thicknesses of solid electrolyte layers;

FIGS. 6A and 6B are views which diagrammatically show relationships between the width and interval of stripe-shaped pattern elements;

FIG. 7 is a drawing which diagrammatically shows a state of applying the positive-electrode active material by the knife coating method;

FIG. 8 is a drawing which diagrammatically shows a vehicle as an example of the device mounted with the battery according to the invention;

FIG. 9 is a drawing which diagrammatically shows an electronic device as another example of the device mounted with the battery according to the invention;

FIG. 10A is a diagram which shows a modification of the battery according to the invention; and

FIG. 10B is a drawing which shows a method for manufacturing this battery.

### DETAILED DESCRIPTION OF THE PREFERRED EMBODIMENTS

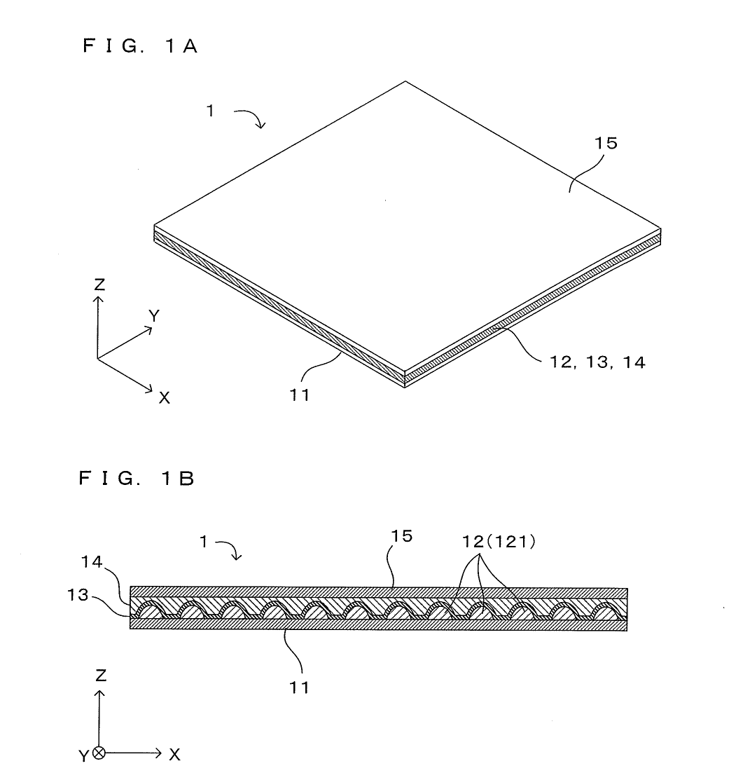

FIG. 1A is a perspective view of a lithium-ion secondary battery as one embodiment of a battery according to the invention. FIG. 1B is a drawing which shows a cross-sectional structure of this battery. This lithium-ion secondary battery module 1 has such a structure that a negative-electrode active material layer 12, a solid electrolyte layer 13, a positive-electrode active material layer 14 and a positive-electrode current collector 15 are successively laminated on a surface of a negative-electrode current collector 11. In this specification, X-, Y- and Z-coordinate directions are respectively defined as shown in FIG. 1A.

As shown in FIG. 1B, the negative-electrode active material layer 12 has a line-and-space structure in which a multitude of stripe-shaped pattern elements 121 formed by a negative-electrode active material and extending in a Y-direction are arranged at regular intervals in an X-direction. On the other hand, the solid electrolyte layer 13 is a continuous thin film formed by a solid electrolyte. The solid electrolyte layer 13 uniformly covers the substantially entire upper surface of a laminated body in such a manner as to conform to (follow) the unevenness on the surface of the laminated body in which the negative-electrode active material layer 12 is formed on the negative-electrode current collector 11 as described above.

The lower surface of the positive-electrode active material layer 14 has an uneven structure in conformity with the unevenness on the upper surface of the solid electrolyte layer 13, whereas the upper surface thereof is a substantially flat surface. The positive-electrode current collector 15 is laminated on the upper surface of the positive-electrode active material layer 14 formed to be substantially flat in this way, whereby the lithium-ion secondary battery module 1 is formed. A lithium-ion secondary battery is formed by appropriately arranging tab electrodes or laminating a plurality of modules on this lithium-ion secondary battery module 1.

Here, known materials for lithium-ion batteries can be used as materials for the respective layers. For example, a copper foil and an aluminum foil can be respectively used as the negative-electrode current collector 11 and the positive-electrode current collector 15. Further, a material mainly containing LiCoO₂ (LCO) can be, for example, used as a positive-electrode active material and a material mainly containing Li₄Ti₅O₁₂ (LTO) can be, for example, used as a negative-electrode active material. Furthermore, polyethylene oxide and polystyrene can be, for example, used as the solid electrolyte layer 13. Note that the materials for the respective functional layers are not limited to these.

The lithium-ion secondary battery module 1 having such a structure is thin and flexible. Since the negative-electrode active material layer 12 is formed to have an uneven space structure as shown and, thereby, increase its surface area with respect to its volume, an area facing the positive-electrode active material layer 14 via the thin solid electrolyte layer 13 can be increased to ensure high efficiency and high output. In this way, the lithium-ion secondary battery having the above structure can be small in size and have high performance.

Next, a method for manufacturing the above lithium-ion secondary battery module 1 is described. Conventionally, a module of this type has been formed by laminating thin film materials corresponding to respective functional layers, but there is a limit in increasing the density of the module by this manufacturing method. Further, with the manufacturing method disclosed in patent literature 1 described above, production takes time due to many operation steps and it is difficult to separate the respective functional layers. In contrast, with the manufacturing method described below, the lithium-ion secondary battery module 1 having the above structure can be produced with a smaller number of operation steps using an existing processing apparatus.

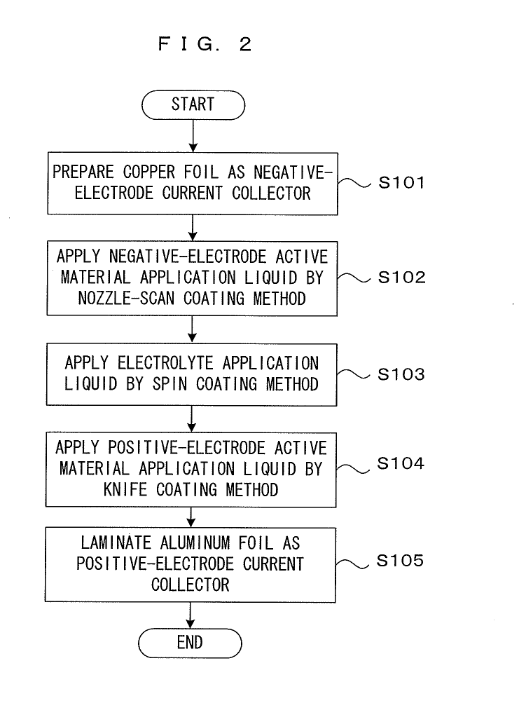

FIG. 2 is a flow chart which shows an example of a method for manufacturing the battery of FIG. 1A. In this manufacturing method, a metal foil, e.g. a copper foil, which will become the negative-electrode current collector 11, is first prepared (Step S101). In the case of using a thin copper foil, it is difficult to transport and handle this foil. Accordingly, it is preferable to improve transportability, for example, by attaching one surface of the copper foil to a carrier such as a glass plate or a resin sheet.

Subsequently, a negative-electrode active material application liquid containing a negative-electrode active material is applied to one surface of the copper foil by a nozzle dispensing method, in particular, by a nozzle-scan coating method for relatively moving a nozzle for dispensing the application liquid with respect to an application target surface (Step S102). An organic LTO material (organic and inorganic composition) containing the negative-electrode active material described above can be, for example, used as the application liquid. A mixture of the above negative-electrode active material, acetylene black or ketjen black as a conduction aid, polyvinylidene fluoride (PVDF), styrene butadiene rubber (SBR), polyvinyl pyrrolidone (PVP), polyvinyl alcohol (PVA) or polytetrafluoroethylene (PTFE) as a binder, N-methyl-2-pyrrolidone (NMP) as a solvent and the like can be used as the application liquid. Note that, besides LTO described above, graphite, metal lithium, SnO₂, alloys and the like can be used as the negative-electrode active material.

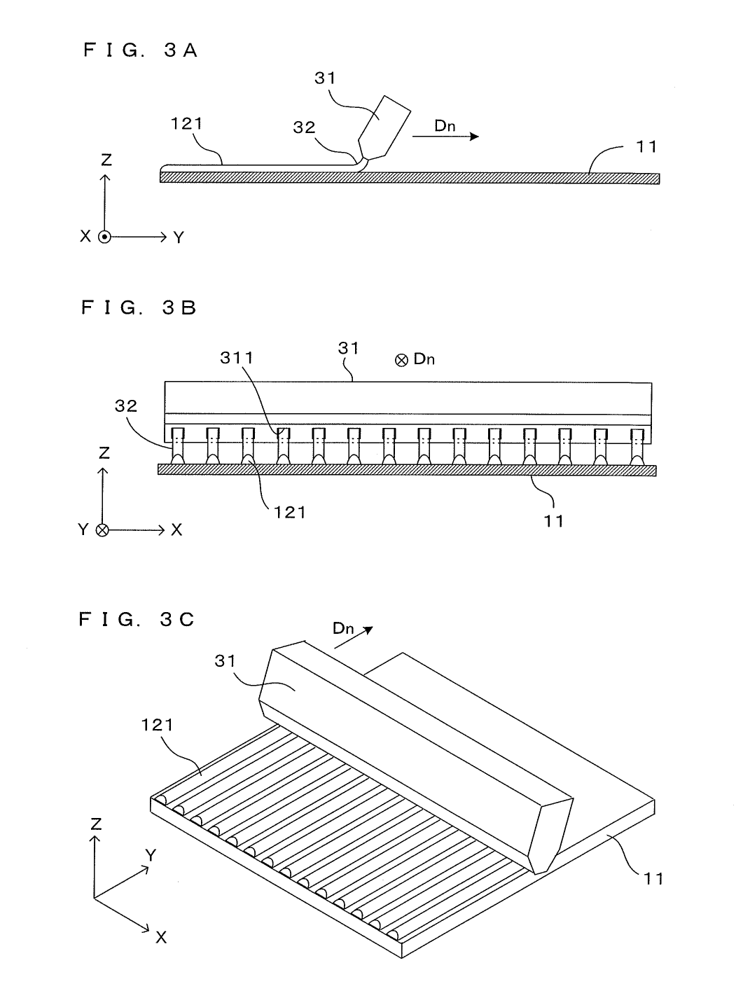

FIG. 3A is a drawing which shows a state of application by the nozzle-scan coating method when viewed in the X-direction, and FIGS. 3B and 3C are drawings showing the same state when viewed in the Y-direction and from a diagonal upper side. A technology for applying an application liquid to a base material by the nozzle-scan coating method is known and such a known technology can be applied also in this method, wherefore an apparatus construction is not described.

In the nozzle-scan coating method, a nozzle 31 perforated with one or more dispense openings 311 for dispensing the above organic LTO material as the application liquid is arranged above a copper foil 11. The nozzle 31 is relatively moved at a constant speed in an arrow direction Dn with respect to the copper foil 11 while dispensing a fixed amount of an application liquid 32 from the dispense opening(s) 311. By doing so, the application liquid 32 is applied on the copper foil 11 in a stripe extending in the Y-direction. By providing the nozzle 31 with a plurality of dispense openings 311, a plurality of stripes can be formed by one movement. By repeating this movement according to need, the application liquid can be applied in stripes on the entire surface of the copper foil 11. By drying and curing the application liquid, the stripe-shaped pattern elements 121 by the negative-electrode active material are formed on the upper surface of the copper foil 11. Heating may be applied after application to promote drying or a photo-curable resin may be added to the application liquid and the application liquid may be cured by light irradiation after application.

At this point of time, an active material layer 12 is partly raised on the substantially flat surface of the copper foil 11. Thus, as compared with the case where the application liquid is simply applied to have a flat upper surface, a surface area can be increased with respect to the used amount of the active material. Therefore, the area facing a positive-electrode active material layer to be formed later can be increased to ensure a high output.

The flow chart of FIG. 2 is further described. An electrolyte application liquid is applied on the upper surface of a laminated body, which is formed by laminating the negative-electrode active material layer 12 on the copper foil 11, by an appropriate coating method, e.g. a spin coating method (Step S103). As the electrolyte application liquid, a mixture of a resin as the above polymer electrolyte material such as polyethylene oxide and polystyrene, a supporting salt such as LiPF₆ (lithium hexafluorophosphate) and a solvent such as diethylene carbonate can be used.

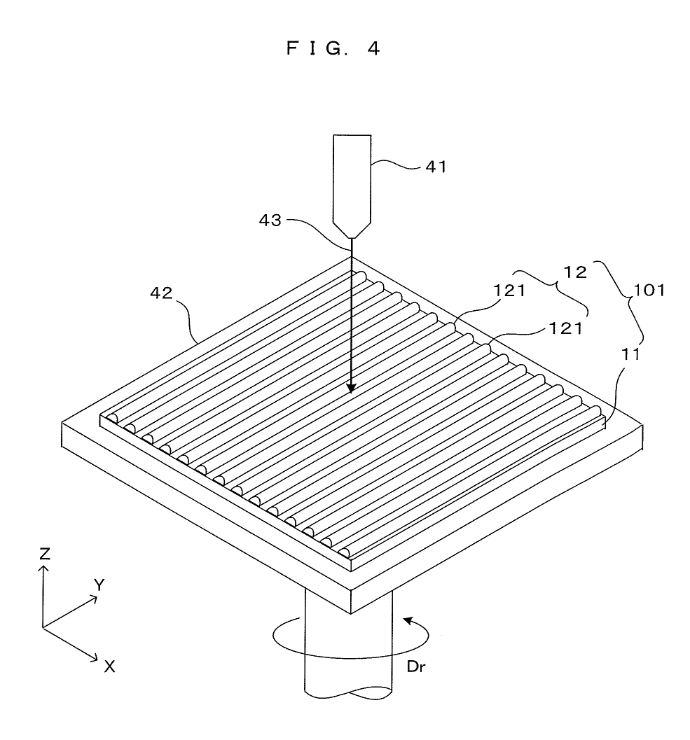

FIG. 4 is a drawing which diagrammatically shows a state of material application by the spin coating method. The laminated body 101 formed by laminating the negative-electrode active material layer 12 made of the stripe-shaped pattern elements 121 on the copper foil 11 is substantially horizontally placed on a rotary stage 42 rotatable in a specified rotational direction Dr about a rotary shaft extending in a vertical direction (Z-direction). Then, the rotary stage 42 is rotated at a specified rotational speed and an application liquid 43 containing a polymer electrolyte material is dispensed toward the laminated body 101 from a nozzle 41 disposed at a position above the rotary shaft of the rotary stage 42. The application liquid dropped onto the laminated body 101 spreads around by a centrifugal force, whereby the excess liquid is shaken off from an end portion of the laminated body 101. By doing so, the upper surface of the laminated body 101 is covered by a thin and uniform layer of the application liquid. In the spin coating method, film thickness can be controlled according to the viscosity of the application liquid and the rotational speed of the rotary stage 42. There is a good track record in forming a thin film with a uniform thickness on an object to be processed having an uneven surface structure such as the laminated body 101 of this application in conformity with the unevenness.

Here, the thickness of the solid electrolyte layer 13 is studied. The solid electrolyte layer 13 has lower ionic conductivity than a liquid electrolyte at and around normal temperature. Thus, to suppress internal resistance of the battery, the solid electrolyte layer 13 is preferably as thin as possible as far as the negative and positive active material layers are reliably separated. In the manufacturing method of this embodiment, the thickness of the solid electrolyte layer 13 is managed as follows.

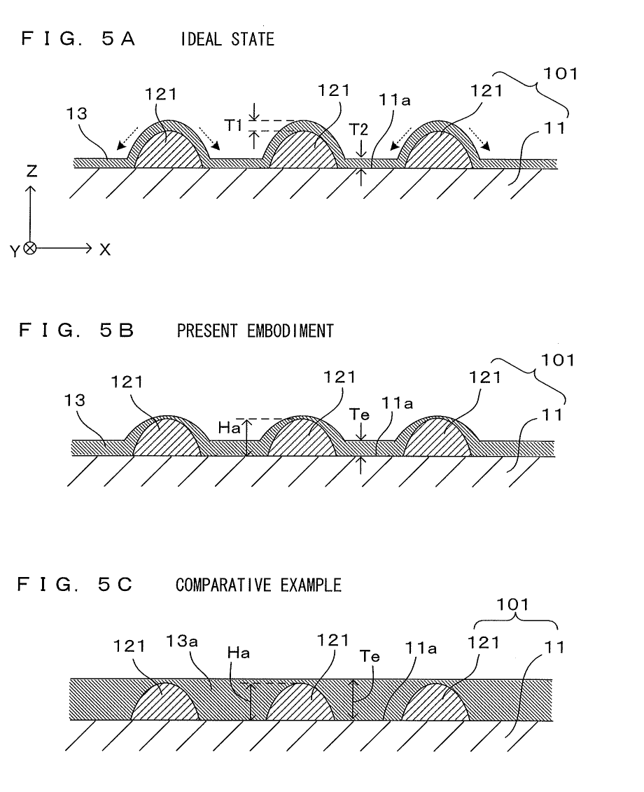

FIGS. 5A, 5B and 5C are views which diagrammatically show thicknesses of solid electrolyte layers. More specifically, these figures are sectional views of laminated bodies each formed by laminating a negative-electrode current collector 11, a negative-electrode active material layer 12 and a solid electrolyte layer 13 and cut along an X-Y plane orthogonal to an extending direction (Y direction) of stripe-shaped pattern elements 121 forming the negative-electrode active material layer 12. In an ideal state, the solid electrolyte layer 13 in the form of a thin layer with a uniform thickness covers the surface of a laminated body 101 of the negative-electrode current collector 11 and the negative-electrode active material layer 12. Accordingly, a thickness T1 of the solid electrolyte layer 13 covering top parts of the stripe-shaped pattern elements 121 made of the negative-electrode active material and a thickness T2 of the solid electrolyte layer 13 covering exposed surfaces 11a of the negative-electrode current collector 11 exposed without having the stripe-shaped pattern elements 121 formed thereon are preferably substantially equal.

However, in the case of forming the solid electrolyte layer 13 by applying an application liquid containing an electrolyte material, it is unavoidable that part of the application liquid applied on the stripe-shaped pattern elements 121 flows down toward the exposed surfaces 11a by gravity as shown by dotted-line arrows in FIG. 5A. This leads to a decrease in the thickness T1 of the solid electrolyte layer 13 covering the stripe-shaped pattern elements 121 and, on the other hand, leads to an increase in the thickness T2 of the solid electrolyte layer 13 covering the exposed surfaces 11a of the negative-electrode current collector 11. Thus, an attempt to uniformize the thickness of the electrolyte layer between the top parts of the stripe-shaped pattern elements 121 and the exposed surfaces of the negative-electrode current collector 11 is not realistic.

Accordingly, in this embodiment, the thickness of the solid electrolyte layer 13 covering the exposed surfaces 11a of the negative-electrode current collector 11 is managed, taking into account such flow-down. By doing so, a battery with good characteristics can be manufactured. Specifically, the thickness of the solid electrolyte layer 13 is so adjusted that a thickness Te of the solid electrolyte layer 13 covering the exposed surfaces 11a of the negative-electrode current collector 11 is smaller than a height Ha in the Z direction of the stripe-shaped pattern elements 121 made of the negative-electrode active material as shown in FIG. 5B. More preferably, the thickness Te is set to be equal to or smaller than half the height Ha in the Z direction. The height of the projection (the stripe-shaped pattern elements 121) of the negative-electrode active material can be defined as a height of the stripe-shaped pattern elements 121 measured from a surface of a flat portion of the laminated body 101, for instance.

A case where a thickness Te of a solid electrolyte layer 13a covering the exposed surfaces 11a of the negative-electrode current collector 11 is larger than the height Ha of the stripe-shaped pattern elements 121 of the negative-electrode active material layer shown in FIG. 5C is considered as a comparative example. In this case, a positive-electrode active material layer laminated on the solid electrolyte layer 13a faces the stripe-shaped pattern elements of the negative-electrode active material layer via the thick solid electrolyte layer 13a, wherefore the significance of providing the negative-electrode active material layer 12 with an uneven pattern is lost.

In this embodiment, the thickness Te of the solid electrolyte layer 13 covering the exposed surfaces 11a of the negative-electrode current collector 11 is set to be smaller than the height Ha of the stripe-shaped pattern elements 121. By doing so, the top parts and side surfaces of the stripe-shaped pattern elements 121 projecting from the surface of the solid electrolyte layer 13 covering the exposed surface 11a face the positive-electrode active material via the thin solid electrolyte layer 13. The smaller the thickness Te of the solid electrolyte layer 13, the more remarkable its effect. According to the knowledge of the inventors of this application, a battery with particularly good characteristics can be obtained when the thickness Te of the solid electrolyte layer 13 covering the exposed surfaces 11a of the negative-electrode current collector 11 is set to be equal to or smaller than half the height Ha of the stripe-shaped pattern elements 121.

In the sense of suppressing an increase in the thickness of the solid electrolyte layer 13 by the application liquid applied on the stripe-shaped pattern elements 121 and flowing down to the surroundings on the exposed surfaces 11a of the negative-electrode current collector 11, a relationship between the width of the stripe-shaped pattern elements 121 and the interval between adjacent ones of the stripe-shaped pattern elements is also important.

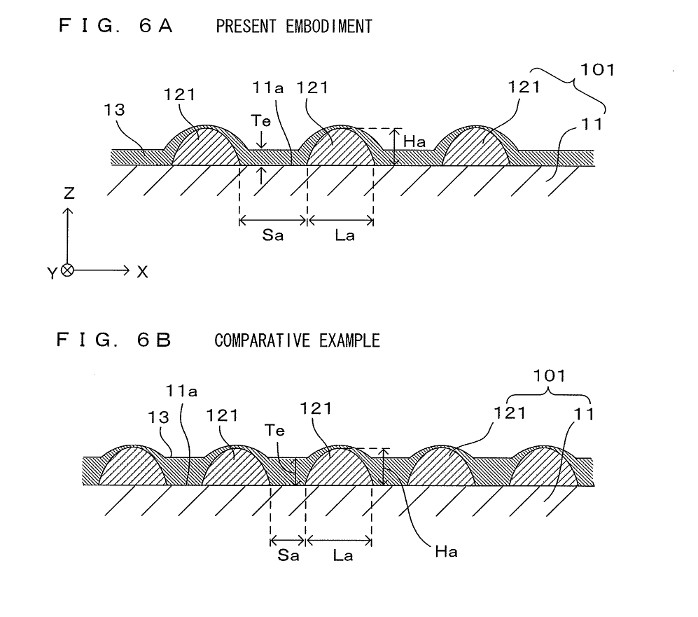

FIGS. 6A and 6B are views which diagrammatically show relationships between the width and interval of stripe-shaped pattern elements. As shown in FIG. 6A, in this embodiment, an interval Sa of the stripe-shaped pattern elements 121 is set to be equal to or larger than a width La of the stripe-shaped pattern elements 121 in an arrangement direction (X direction) of the stripe-shaped pattern elements 121. Here, the width La of the stripe-shaped pattern elements 121 is defined as a width on a contact surface with the negative-electrode current collector 11. Under such a dimensional relationship, the area of parts of the surface of the negative-electrode current collector 11 covered by the stripe-shaped pattern elements 121 is equal to or smaller than the area of parts of this surface not covered by the stripe-shaped pattern elements 121. In other words, the area of the parts of the surface of the negative-electrode current collector 11 covered by the stripe-shaped pattern elements 121 is ½ or smaller than the area of the entire surface. By making the interval Sa of the stripe-shaped pattern elements 121 wide, the electrolyte application liquid having flowed down from upper parts of the stripe-shaped pattern elements 121 spreads over the entire exposed surfaces 11a, wherefore the thickness Te of the solid electrolyte layer 13 does not largely increase.

On the contrary, the application liquid down from the stripe-shaped pattern elements 121 flows into narrow clearances if the interval Sa is smaller than the width La of the stripe-shaped pattern elements 121 as in a comparative example shown in FIG. 6B. Thus, the thickness Te of the solid electrolyte layer 13 largely increases. Further, in the case of applying the electrolyte application liquid by the spin coating method as in this embodiment, the application liquid may stay at bottom parts and may not be able to be shaken off by rotation if the stripe interval Sa is small. Also in this regard, the stripe interval Sa is preferably larger than the width La of the stripe-shaped pattern elements 121.

For example, it is assumed that the stripe interval Sa is the K-fold of the width La of the stripe-shaped pattern elements 121. At this time, if the thickness Te of the electrolyte layer immediately after application (uncured state) is smaller than (1/K) of the height Ha of the stripe-shaped pattern elements 121, the thickness Te of the solid electrolyte layer 13 does not exceed the height Ha of the stripe-shaped pattern elements 121 even if the application liquid applied on the stripe-shaped pattern elements 121 mostly flows down.

According to the knowledge of the inventors of this application, when the thickness Te of the solid electrolyte layer 13 is fixed at 20 μm in terms of obtaining a thin film with good quality by application, particularly good characteristics are obtained when:

20≦La≦250 [μm]

and

1.4 La≦Sa≦500 [μm].

In terms of effectively increasing the surface area of the active material layer, it is preferable that an aspect ratio (=Ha/La) of each stripe-shaped pattern element 121 is large, i.e. a cross-sectional area Da of each stripe-shaped pattern element 121 is large even at the same width La. In this regard, a preferable range was:

200≦Da≦125000 [μm2].

The flow chart of FIG. 2 is further described. The positive-electrode active material layer 14 is formed on a laminated body which is formed by laminating the copper foil 11, the negative-electrode active material layer 12 and the solid electrolyte layer 13 in this way (Step S104). The positive-electrode active material layer 14 is formed by applying a positive-electrode active material application liquid containing positive-electrode active material by an appropriate coating method, e.g. a known knife coating method. An aqueous LCO material obtained by mixing the positive-electrode active material, acetylene black as a conduction aid, SBR as a binder, carboxymethylcellulose (CMC) as a dispersant and pure water as a solvent can be, for example, used as the application liquid containing the positive-electrode active material. Besides the above LCO, LiNiO₂, LiFePO₄, LiMnPO₄, LiMn₂O₄ or compounds represented by LiMeO₂ (Me=MₓM_{y}M_{z}; Me, M are transition metal elements and x+y+z=1) such as LiNi_{1/3}Mn_{1/3}Co_{1/3}O₂ and LiNi_{0.8}CO_{0.15}Al_{0.05}O₂ can be used as the positive-electrode active material. Further, besides the knife coating method illustrated below, known coating methods capable of forming a flat film on a flat surface such as a bar coating method and a spin coating method can be appropriately employed as the coating method.

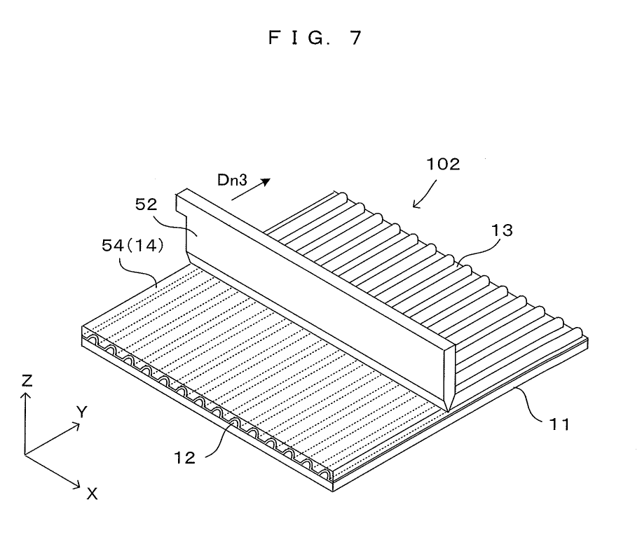

FIG. 7 is a drawing which diagrammatically shows a state of applying the positive-electrode active material by the knife coating method. The application liquid containing the positive-electrode active material is discharged to the upper surface of a laminated body 102 from an unillustrated nozzle. A blade 52 arranged in proximity to the upper surface of the laminated body 102 moves in a direction of arrow Dn3 along the upper surface of the laminated body 102 while the bottom end thereof touches the application liquid. In this way, the upper surface of an application liquid 54 is leveled.

By applying the application liquid 54 containing the positive-electrode active material on the laminated body 102 while leveling it in this way, the positive-electrode active material layer 14 is formed on the laminated body 102 formed by laminating the negative-electrode current collector 11, the negative-electrode active material layer 12 and the solid electrolyte layer 13. The positive-electrode active material layer 14 has the uneven lower surface in conformity with the unevenness on the solid electrolyte layer 13, whereas the upper surface thereof is substantially flat. It is appropriate to set the thickness of the positive-electrode active material layer 14 at 20 μm to 100 μm.

Referring back to FIG. 2, the flow chart is further described. A metal foil, e.g. an aluminum foil which will become a positive-electrode current collector 15 is laminated on the upper surface of the positive-electrode active material layer 14 formed in this way (Step S105). At this time, it is desirable to superimpose the positive-electrode current collector 15 on the upper surface of the positive-electrode active material layer 14 formed in previous Step S104 before the positive-electrode active material layer 14 is cured. By doing so, the positive-electrode active material layer 14 and the positive-electrode current collector 15 can be tightly bonded to each other. Since the upper surface of the positive-electrode active material 14 is leveled, the positive-electrode current collector 15 can be easily laminated without forming any clearance.

As described above, in this embodiment, the negative-electrode active material layer 12 having the line-and-space structure is formed by applying the negative-electrode active material application liquid on the negative-electrode current collector 11 by the nozzle-scan coating method. By this, it is possible to form the negative-electrode active material layer 12 having a large surface area with respect to the volume of the material. According to the application using the nozzle-scan coating method, a considerably larger amount of application liquid can be continuously discharged as compared with the prior art ink jet method described above. Therefore, the negative-electrode active material layer 12 having an uneven pattern with a large height difference can be formed in a short time.

Then, the solid electrolyte layer 13 is formed by applying the electrolyte application liquid in such a manner as to cover the negative-electrode active material layer 12 and the exposed surfaces 11a of the negative-electrode current collector 11. At this time, the thickness of the solid electrolyte layer 13 is managed, taking into account that the application liquid flows down from the stripe-shaped pattern elements 121 of the negative-electrode active material layer 12 toward the exposed surfaces 11a. Accordingly, various application methods capable of controlling the film thickness on the substantially flat exposed surfaces 11a can be employed and no special application method is required. Then, the positive-electrode active material layer 14 is further formed by applying the positive-electrode active material application liquid and the positive-electrode current collector 15 is laminated, whereby the lithium-ion secondary battery module 1 shown in FIG. 1B is formed. In such a structure, both positive and negative-electrode active materials face each other in a wide area via the thin solid electrolyte layer.

The lithium-ion secondary battery module 1 manufactured in this way is thin and good in electrochemical properties. A battery manufactured using this is an all-solid-state battery containing no organic solvent, is easily handled and has a small size and excellent performances. Such a battery can be used in machines such as electric vehicles, electrically assisted bicycles, electric tools and robots, mobile devices such as personal computers, mobiles phones, mobile music players, digital cameras and video camera, and various electronic devices such as smart IC cards, game machines, portable measurement devices, communication devices and toys.

Examples of devices mounted with the battery according to the invention are described below. However, these are only illustration of some forms of devices to which the battery of this embodiment is applicable and a range of application of the battery according to the invention is not limited to these.

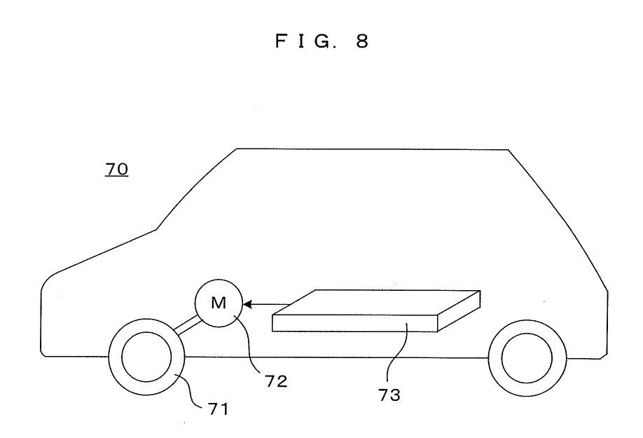

FIG. 8 is a drawing which diagrammatically shows a vehicle, specifically an electric vehicle as an example of the device mounted with the battery according to the invention. This electric vehicle 70 includes wheels 71, a motor 72 for driving the wheels 71, and a battery 73 for supplying power to the motor 72. A multitude of lithium-ion secondary battery modules 1 connected in series and/or parallel to each other can be employed as this battery 73. Since the thus constructed battery 73 is small in size, has a high power supply capability and is rechargeable in a short time, it is suitable as a power supply for driving a vehicle such as the electric vehicle 70.

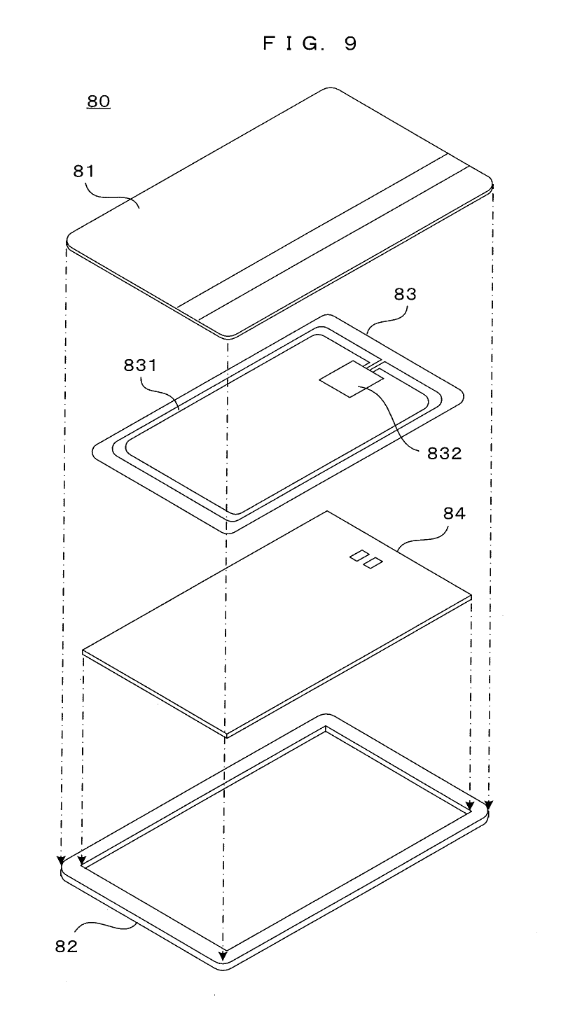

FIG. 9 is a drawing which diagrammatically shows an electronic device, specifically an IC card (smart card) as another example of the device mounted with the battery according to the invention. This IC card 80 includes a pair of housings 81, 82 which constitute a card type package by being fitted together, a circuit module 83 to be housed in these housings and a battery 84 which serves as a power supply for the circuit module 83. Out of these, the circuit module 83 includes a loop antenna 831 for external communication and a circuit block 832 with an integrated circuit (IC) for performing data exchange with external devices via the antenna 831 and various calculation and storage processes. One set or a plurality of sets of lithium-ion secondary battery modules 1 described above may be used as the battery 84.

According to this construction, a communication distance with external devices can be more extended as compared with general IC cards including no power supply themselves and more complicated processes can be performed. Since the battery 84 according to the invention is small in size and thin and can ensure a high capacity, it can be suitably applied to such card type devices.

As described above, in this embodiment, the negative-electrode current collector 11 corresponds to a “base material” and a “first current collector layer” of the invention, and the negative-electrode active material and the negative-electrode active material layer 12 respectively to a “first active material” and a “first active material layer” of the invention. The stripe-shaped pattern elements 121 correspond to a “projection” of the invention. The negative-electrode active material application liquid corresponds to a “first application liquid” of the invention. The positive-electrode current collector 15 corresponds to a “second current collector layer” of the invention, and the positive-electrode active material and the positive-electrode active material layer 14 respectively to a “second active material” and a “second active material layer” of the invention. The electrolyte application liquid and the positive-electrode active material application liquid respectively correspond to a “second application liquid” and a “third application liquid” of the invention.

In the battery manufacturing method (FIG. 2) according to this embodiment, Step S102 corresponds to an “active material applying step” of the invention and Step S103 to an “electrolyte layer forming step” of the invention.

The invention is not limited to the above embodiment and various changes other than the above can be made without departing from the gist thereof. For example, the coating methods employed in the respective steps are not limited to the above ones and other coating methods may be employed provided that they serve the purposes of these steps. For example, in the above embodiment, the spin coating method is employed to form the solid electrolyte layer 13. However, the application liquid containing the polymer electrolyte may be applied by another method capable of forming a thin film in conformity with the unevenness on the application target surface and controlling film thickness on exposed surfaces of the substantially flat base material such as a spray coating method. Further, since the electrolyte layer needs not have large thickness, it may be applied by the ink jet method.

In the above embodiment, the surface of the negative-electrode current collector 11 is partly exposed since the stripe-shaped pattern elements 121 are directly formed on the surface of the negative-electrode current collector 11. However, the entire surface of the negative-electrode current collector 11 may be covered by an uneven negative-electrode active material layer, for example, as described below.

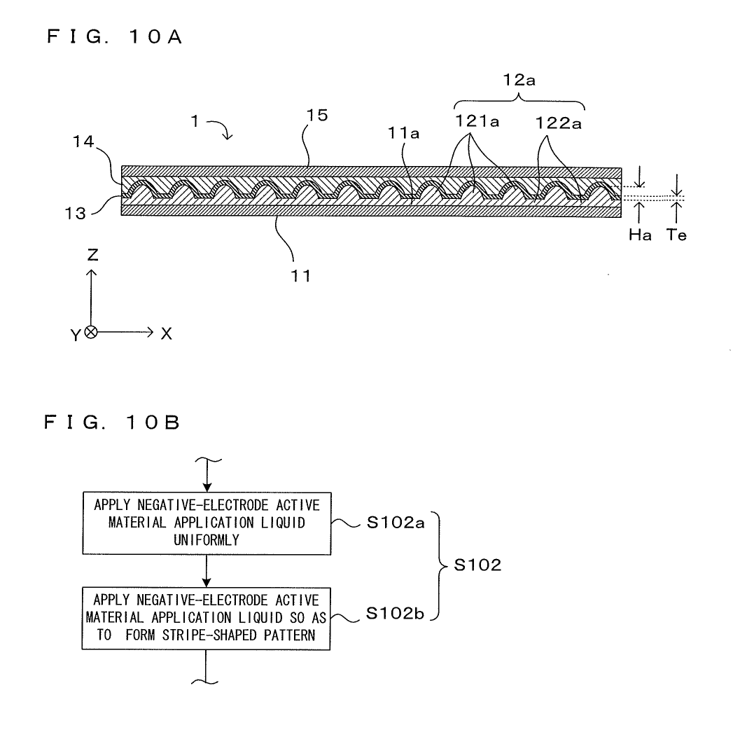

FIG. 10A is a diagram which shows a modification of the battery according to the invention, and FIG. 10B is a drawing which shows a method for manufacturing this battery. In the example shown in FIG. 10A, a negative-electrode active material layer 12a is formed by the nozzle-scan coating method as in the above and includes projected portions 121a formed by a negative-electrode active material and projecting upward (Z-direction) from a surface 11a of a negative-electrode current collector 11 and flat portions 122a covering the surface 11a of the negative-electrode current collector 11 located between the projecting portions 121a. In such a structure, the negative-electrode current collector 11 and a solid electrolyte layer 13 are not in direct contact and the negative-electrode active material is invariably present between them. Accordingly, contact areas increase between the negative-electrode current collector 11 and the negative-electrode active material layer 12a and between the negative-electrode active material layer 12a and the solid electrolyte layer 13, wherefore charge and discharge characteristics as a battery can be further improved.

To obtain such a structure, Step S102 in the flow chart of FIG. 2 may be partly changed, for example, as shown in FIG. 10B. In Substep S102a of Step S102, a negative-electrode active material application liquid is thinly and uniformly applied on a surface of a copper foil as the negative-electrode current collector 11. Various coating methods capable of forming a film with a substantially uniform thickness can be employed as the coating method at this time. For example, the nozzle-scan coating method, knife coating method, doctor blade method, spin coating method, spray coating method and the like can be employed. In this case, a laminated body formed by laminating the flat negative-electrode active material layer on the current collector 11 corresponds to the “base material” of the invention.

Subsequently, in Substep S102b, the negative-electrode active material application liquid is applied on a surface of the negative-electrode active material layer formed on the current collector 11 by the nozzle-scan coating method as in the above embodiment, thereby forming stripe-shaped pattern elements. Further, the thickness of the solid electrolyte layer 13 covering the flat portion 122a out of the negative-electrode active material layer 12a is adjusted smaller than a height Ha of the stripe-shaped pattern elements 121a from the surface of the base material, in other words, than the height difference of the unevenness of the negative-electrode active material 12a. The height Ha in this case can be defined as a height of the projected portion (the stripe-shaped pattern elements 121a) of the negative-electrode active material layer 12a measured from a surface of the flat portion 122a of the negative-electrode active material layer 12a. More preferably, the area of the parts of the surface of the base material covered by the projections 121a is ½ or smaller than the area of the entire surface of the base material. By this, the structure shown in FIG. 10A can be obtained.

A similar structure can be also formed by pouring the negative-electrode active material layer liquid between the pattern elements after the stripe-shaped pattern elements are formed on the surface of the negative-electrode current collector 11. In this case, there is no problem in applying the application liquid on the formed stripe-shaped pattern elements since they are of the same material. Further, the projecting portions 121a and the flat portions 122a may be formed by changing the thickness of the active material by changing the discharging amount of the application liquid from the nozzle depending on positions.

For example, in the above embodiment, the negative-electrode active material layer 12 has the line-and-space structure made up of a multitude of stripe-shaped pattern elements parallel to each other, but the coating pattern of the negative-electrode active material is not limited to this. Any arbitrary pattern may be used provided that the surface area thereof is increased by providing an uneven structure on the surface. Further, the respective stripe-shaped pattern elements 121 may be connected to each other. In these cases, it is also preferable that the area of the parts of the surface of the base material covered by the projections made of the negative-electrode active material is ½ or smaller than the area of the entire surface of the base material

For example, in the above embodiment, the knife coating method is employed to form the positive-electrode active material layer 14, but another method may be employed provided that it is a coating method capable of finishing the positive-electrode active material layer 14 such that the lower surface in contact with the application target surface follows the unevenness on the application target surface and the upper surface is substantially flat. The viscosity of the application liquid is desirably not too high to accomplish such an object. However, if the viscosity of the application liquid is appropriately selected, even another coating method can finish the positive-electrode active material layer such that the lower surface is uneven and the upper surface is substantially flat. For example, the application liquid may be poured into recessed portions of the unevenness on the application target surface by the nozzle-scan coating method.

In the above embodiment, the negative-electrode active material layer, the solid electrolyte layer, the positive-electrode active material layer and the positive-electrode current collector are successively laminated on the negative-electrode current collector. However, contrary to this, the positive-electrode active material layer, the solid electrolyte layer, the negative-electrode active material layer and the negative-electrode current collector may be laminated in this order on the positive-electrode current collector.

The materials such as the current collectors, the active materials and the electrolyte illustrated in the above embodiment are merely examples and there is no limitation to these. Also in the case of manufacturing a lithium-ion battery using other materials used as constituent materials for lithium-ion batteries, the manufacturing method of the invention can be suitably employed. The invention is also applicable to production of chemical batteries (all-solid-state batteries) in general using other materials without being limited to lithium-ion batteries.

According to the knowledge of the inventors of this application, battery characteristics can be more improved if the thickness of the electrolyte layer covering the exposed surface of the base material is reduced to or below half the height of the projection. Further, it is known that an increase in the thickness of the electrolyte layer resulting from the flow-down of the application liquid from the projection can be effectively suppressed if the area of a part of the base material surface covered by the projection made of the first active material is set to be equal to or smaller than ½ of the entire base material surface.

Accordingly, in the battery manufacturing method of the invention, a plurality of stripe-shaped projections extending along the surface of the base material may be formed, for example, in the active material applying step and widths of the respective projections may be set to be equal to or smaller than intervals between adjacent ones of the projections. Such a space structure is so called a line and space structure, which is suitable for forming a space structure by liquid application in a short time. By setting the widths of the projections to be equal to or smaller than the intervals between the adjacent projections, the area of the parts of the base material surface covered by the projections is suppressed to be equal to or smaller than ½ of the area of the entire base material surface, whereby the increase in the thickness of the electrolyte layer described above can be suppressed.

Further, according to the knowledge of the inventors of this application, the thus manufactured battery exhibited particularly good characteristics when the widths of the projections were 20 μm to 250 μm and the intervals between the projections were 500 μm or less or when a cross-sectional area of each projection in a plane orthogonal to an extending direction of the projections was 200 μm² to 125000 μm².

In the active material applying step of this invention, the first application liquid may be, for example, discharged from a nozzle which relatively moves with respect to the base material surface and applied on the base material surface. Such an application technology by the so-called nozzle dispensing method has a good track record in being able to apply an application liquid in a fine uneven pattern and can be suitably applied for application of the first application liquid in the invention. Since a thick pattern can be formed in a short time by this method, batteries can be manufactured with significantly higher productivity as compared with the conventional technology disclosed in patent literature 1 employing the ink jet method.

The base material in this invention may be a conductive sheet which will become a first current collector corresponding to the first active material. Alternatively, the base material may be a laminated body in which a film made of the first active material is laminated beforehand on a principal surface where the first application liquid is to be applied out of principle surfaces of a conductive sheet which will become a first current collector. In the case of directly forming the projection made of the first active material on a surface of the conductive sheet, the conductive sheet and the projection respectively function as a current collector layer and an active material layer. Further, in the case of the base material in which the active material layer is formed on the conductive sheet, the projection to be formed later and the active material film formed on the base material beforehand integrally function as an active material layer. In this case, it becomes possible to manufacture a battery with better characteristics since the surface area of the active material layer can be further increased.

In the battery manufacturing method according to this invention, it is preferable that a second active material layer and a second current collector layer are further laminated on the electrolyte layer formed as described above. By doing so, a battery in which first and second active material layers face each other in a wide area via a thin solid electrolyte layer can be obtained, wherefore it is possible to obtain a battery with a thin size and good characteristics.

In this case, the second active material layer may be formed by applying a third application liquid containing a second active material on the surface of the electrolyte layer. By forming the second active material layer by application of the application liquid, the second active material layer, a contact surface of which with the electrolyte layer has unevenness in conformity with that on the surface of the electrolyte layer, can be formed. Therefore, it is possible to manufacture a battery with large contact areas with the second active material layer and the electrolyte layer and good characteristics.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. A battery manufacturing method, comprising:
an active material applying step of applying a first application liquid containing a first active material on a surface of a base material to form a projection of the first active material projecting from the surface of the base material; and
an electrolyte layer forming step of applying a second application liquid containing a solid electrolyte material on the surface of the base material formed with the projection to form an electrolyte layer, which covers a surface of the projection and an exposed surface of the base material where the projection is not formed, of the solid electrolyte material,
wherein a thickness of the electrolyte layer covering the exposed surface of the base material is set to be smaller than a height of the projection from the base material surface.

2. The battery manufacturing method according to claim 1, wherein, in the electrolyte layer forming step, the thickness of the electrolyte layer covering the exposed surface of the base material is set to be equal to or smaller than ½ of the height of the projection from the base material surface.

3. The battery manufacturing method according to claim 1, wherein, in the active material applying step, the area of a part of the base material surface covered by the projection is set to be equal to or smaller than ½ of the entire base material surface.

4. The battery manufacturing method according to claim 3, wherein, in the active material applying step, a plurality of stripe-shaped projections extending along the base material surface are formed and widths of the respective projections are set to be equal to or smaller than intervals between adjacent ones of the projections.

5. The battery manufacturing method according to claim 4, wherein the widths of the projections are 20 μm to 250 μm and the intervals between the projections are equal to or less than 500 μm.

6. The battery manufacturing method according to claim 4, wherein a cross-sectional area of each projection in a plane orthogonal to an extending direction of the projections is 200 μm² to 125000 μm².

7. The battery manufacturing method according to claim 1, wherein, in the active material applying step, the first application liquid is discharged from a nozzle which relatively moves with respect to the base material surface and applied on the base material surface.

8. The battery manufacturing method according to claim 1, wherein the base material is a laminated body in which a film made of the first active material is laminated on a principle surface on which the first application liquid is to be applied out of principle surfaces of a conductive sheet which will become a first current collector.

9. The battery manufacturing method according to claim 1, wherein a second active material layer and a second current collector layer are further laminated on a surface of the electrolyte layer.

10. The battery manufacturing method according to claim 9, wherein a third application liquid containing a second active material is applied on the surface of the electrolyte layer to form the second active material layer.

11. A battery comprising: a first current collector layer; a first active material layer; a solid electrolyte layer; a second active material layer; and a second current collector layer, wherein
at least the first active material layer and the solid electrolyte layer are formed by the manufacturing method according to claim 1 using the first current collector layer as the base material.

12. A vehicle, comprising:
a motor; and
the battery according to claim 11 for supplying power to the motor.

13. An electronic device, comprising:
the battery according to claim 11; and
a circuit unit which operates using the battery as a power supply.
